(19) United States
(12) Patent Application Publication
(10) Pub. No.: US 2013/0288869 A1
(43) Pub. Date: Oct. 31, 2013

(54) ELECTRICALLY CONDUCTIVE ROLLER

(71) Applicant: SUMITOMO RUBBER INDUSTRIES, LTD., Kobe-shi (JP)

(72) Inventor: Kei TAJIMA, Kobe-shi (JP)

(73) Assignee: SUMITOMO RUBBER INDUSTRIES, LTD., Kobe-shi (JP)

(21) Appl. No.: 13/759,704

(22) Filed: Feb. 5, 2013

(30) Foreign Application Priority Data
Apr. 27, 2012 (JP) 2012-103667

(51) Int. Cl. B05C 1/08; G03G 15/02

(52) U.S. Cl. CPC G03G 15/0233
USPC 492/18; 399/176

(57) ABSTRACT

An electrically conductive roller is provided which has a stable roller resistance with little batch-to-batch variation in roller resistance and substantially without influence of environmental conditions and the like, and is unlikely to contaminate the photo receptor. The electrically conductive roller (1) includes a roller body (2) made of a crosslinking product of an electrically conductive rubber composition prepared by blending a potassium salt of an anion having a fluoro group and a sulfonyl group in its molecule and a crosslinking component in a base polymer which is a mixture containing an epichlorohydrin rubber E and a diene rubber N in a mass ratio E/N of 50/50 to 80/20, and an oxide film (6) formed in an outer peripheral surface (5) thereof by irradiation with ultraviolet radiation.

### TECHNICAL FIELD

The present invention relates to an electrically conductive roller which can be advantageously used as a charging roller or the like in an electrophotographic image forming apparatus such as a laser printer, an electrostatic copying machine, a plain paper facsimile machines or a printer-copier-facsimile multifunction machine.

### BACKGROUND ART

Electrophotographic image forming apparatuses have been improved in various ways in order to satisfy requirements for higher printing speed, higher image quality, full-color image formation and smaller size.

In order to increase the printing speed of such an image forming apparatus, it is effective to minimize the electrical resistance of a charging roller which is adapted to electrically charge a drum-shaped photoreceptor in contact with a surface of the photoreceptor.

A popular electrically conductive roller serving as the charging roller includes a roller body having a surface layer at least including an outer peripheral surface and made of a crosslinking product of an electrically conductive rubber composition. The electrically conductive rubber composition typically contains a base polymer including a diene rubber and an ion conductive rubber such as an epichlorohydrin rubber, and a crosslinking component for crosslinking the base polymer.

Further, the outer peripheral surface of the roller body is preferably covered with a protective film. The charging roller is used in direct contact with the photoreceptor, so that a component of the electrically conductive rubber composition bloomed or bled onto the outer peripheral surface of the roller body should be prevented from contaminating the photoreceptor and influencing an image to be formed. Further, additives contained in a toner should be prevented from adhering to the outer peripheral surface of the roller body and influencing the image to be formed.

An oxide film is advantageously formed as the protective film in the outer peripheral surface of the roller body through oxidation of the diene rubber contained in the electrically conductive rubber composition by irradiation of the outer peripheral surface of the roller body with ultraviolet radiation.

Advantageously, the oxide film is uniformly formed as having an even thickness, because the outer peripheral surface of the roller body can be uniformly oxidized by the irradiation with the ultraviolet radiation without any fear of contamination with foreign matter such as dust in an oxide film forming step.

For reduction of the electrical resistance of the entire electrically conductive roller (roller resistance), an ionic electrically-conductive salt is blended in the electrically conductive rubber composition.

A lithium salt of an anion (hereinafter often referred to simply as “lithium salt”) such as lithium bis(trifluoromethanesulfonyl)imide having a fluoro group and a sulfonyl group in its molecule is widely used as the electrically conductive salt, because the lithium salt is highly effective for the reduction of the roller resistance of the electrically conductive roller (see, for example, JP-2011-257723A). For example, addition of even a small amount of the lithium salt can reduce the roller resistance to an order of 10⁵Ω.

However, the lithium salt is highly hygroscopic and deliquescent and, therefore, is liable to absorb moisture to suffer from a change in weight or deliquesce during weighing thereof. This makes it difficult to accurately weigh the lithium salt. In addition, the change in weight due to the moisture absorption is often influenced by the environmental conditions (particularly the humidity and the temperature) to suffer from batch-to-batch variations when the electrically conductive rubber composition is prepared by adding the lithium salt.

The batch-to-batch variations in the actual content of the lithium salt may result in batch-to-batch variations in the roller resistance of the electrically conductive roller including the roller body formed by using the electrically conductive rubber composition containing the lithium salt.

Further, the electrically conductive roller including the roller body containing the lithium salt is liable to be influenced by the environmental conditions (particularly the humidity) even after the production thereof to suffer from a change in roller resistance due to the moisture absorption, and the change in roller resistance is significant. Therefore, the charging characteristics significantly vary depending on the environmental conditions in which the electrically conductive roller is used, for example, as the charging roller in the image forming apparatus. This may result in significant variations, for example, in the image density of the entire formed image.

In addition, the electrically conductive roller serving as the charging roller is liable to cause streaking in the formed image, for example, when the operation of the image forming apparatus is restarted after being once stopped with the electrically conductive roller in direct contact with the surface of the photoreceptor, particularly in a higher temperature/higher humidity environment.

That is, the electrically conductive roller is liable to absorb a greater amount of moisture, particularly in the higher temperature/higher humidity environment, and the moisture contaminates a linear region of the surface of the photoreceptor in contact with the charging roller during the stop of the image forming apparatus to locally reduce the resistance of the region. As a result, the streaking occurs in several images formed immediately after the operation of the image forming apparatus is restarted.

### SUMMARY OF THE INVENTION

It is an object of the present invention to provide an electrically conductive roller which has a stable roller resistance with little batch-to-batch variation in roller resistance and substantially without influence of the environmental conditions and the like, and is unlikely to contaminate the photoreceptor.

The present invention provides an electrically conductive roller which includes a roller body having a surface layer at least including an outer peripheral surface thereof and made of a crosslinking product of an electrically conductive rubber composition, and an oxide film formed in the outer peripheral surface by irradiation with ultraviolet radiation, the electrically conductive rubber composition comprising:

(1) a base polymer which is a mixture containing an epichlorohydrin rubber E and a diene rubber N in a mass ratio E/N of 50/50 to 80/20;
(2) a crosslinking component for crosslinking the base polymer; and
(3) a potassium salt of an anion (hereinafter often referred to simply as “potassium salt”) having a fluoro group and a sulfonyl group in its molecule.

According to the present invention, the potassium salt (3), which is used as the ionic electrically-conductive salt instead of the conventional lithium salt, has substantially the same functions as the lithium salt, but is non-hygroscopic and non-deliquescent unlike the lithium salt. Without the possibility that the potassium salt suffers from the significant change in weight due to the moisture absorption and deliquesces during the weighing thereof, it is easier to accurately weigh the potassium salt. Further, the electrically conductive rubber composition is less liable to suffer from the batch-to-batch variations in moisture absorption during the preparation thereof.

The actual content of the potassium salt can be maintained substantially constant for each preparation batch. Therefore, the electrically conductive roller including the roller body formed by using the electrically conductive rubber composition containing the potassium salt is prevented from suffering from the batch-to-batch variations in roller resistance.

Further, the roller resistance of the electrically conductive roller is prevented from being influenced by the environmental conditions and the like and hence from significantly varying due to moisture absorption. Therefore, when the electrically conductive roller is used, for example, as the charging roller in the image forming apparatus, the variations in the charging characteristics of the charging roller depending on the environmental conditions can be suppressed. Thus, the image density of the entire formed image can be always maintained consistent.

In addition, the electrically conductive roller does not absorb a great amount of moisture even in the higher temperature/higher humidity environment and, therefore, does not cause the streaking in the formed image without the contamination of the photoreceptor with the moisture, for example, when the operation of the image forming apparatus is restarted after being once stopped in the higher temperature/higher humidity environment.

In the paragraph [0036] in JP-2011-257723A, the potassium ion is shown as one example of a cation which forms an ionic electrically-conductive salt together with the anion having the fluoro group and the sulfonyl group in the molecule.

However, JP-2011-257723A does not state that the potassium salt of the anion provides the aforementioned various effects because the potassium salt is non-hygroscopic and non-deliquescent unlike the lithium salt which is regarded as optimum in JP-2011-257723A. Further, JP-2011-257723A actually confirms only the effects of the addition of the lithium salt, but does not confirm the effects of the addition of the potassium salt.

Therefore, the description of the electrically conductive salt in JP-2011-257723A neither teaches nor suggests the present invention.

In the present invention, the mass ratio E/N between the epichlorohydrin rubber E and the diene rubber N serving as the base polymer is limited within the range of 50/50 to 80/20 for the following reason:

The diene rubber N is a material for forming an oxide film functioning as a protective film in the outer peripheral surface of the roller body through the oxidation by the irradiation with the ultraviolet radiation as described above. If the proportion of the diene rubber N is less than the aforementioned range, it is impossible to satisfactorily form the oxide film.

Therefore, when the resulting electrically conductive roller is incorporated, for example, as the charging roller in the image forming apparatus and brought into direct contact with the photoreceptor, a component of the electrically conductive rubber composition bloomed or bled onto the outer peripheral surface from the roller body cannot be effectively prevented from contaminating the photoreceptor and influencing the image to be formed.

Further, the outer peripheral surface of the roller body is changed by repeated image formation, so that the additives contained in the toner are liable to adhere to the outer peripheral surface. This makes it impossible to effectively prevent the additives from influencing the image to be formed.

On the other hand, if the proportion of the epichlorohydrin rubber E is less than the aforementioned range, the epichlorohydrin rubber E cannot effectively impart the roller body with proper electrical conductivity, failing to control the roller resistance of the electrically conductive roller within a range suitable for the charging roller. Further, when the resulting electrically conductive roller is incorporated as the charging roller in the image forming apparatus and the image formation is repeated, the roller resistance is liable to further increase to cause an imaging failure in the formed image.

In contrast, where the mass ratio E/N between the epichlorohydrin rubber E and the diene rubber N serving as the base polymer falls within the aforementioned range, an oxide film sufficiently functioning as the protective film can be formed in the outer peripheral surface of the roller body. In addition, the roller resistance of the electrically conductive roller can be maintained within a range suitable for the image formation for a longer period of time from the initial stage.

A salt of the potassium cation and any of anions having the fluoro group and the sulfonyl group in the molecule is usable as the potassium salt (3). Particularly, the anion has a smaller molecular weight. Therefore, potassium bis(fluorosulfonyl)imide is preferred, which can reduce the roller resistance of the electrically conductive roller by increasing the amount of the potassium ion even with the addition of the same amount of the potassium salt.

It is preferred to use a thiourea crosslinking agent and an accelerating agent for crosslinking the epichlorohydrin rubber, and at least one crosslinking agent selected from the group consisting of sulfur and a sulfur-containing crosslinking agent and a sulfur-containing accelerating agent for crosslinking the diene rubber in combination as the crosslinking component (2).

The electrically conductive rubber composition may contain at least one additive selected from the group consisting of a crosslinking assisting agent, an acid accepting agent, a processing aid, a filler, an anti-aging agent, an antioxidant, an anti-scorching agent, a UV absorbing agent, a lubricant, a pigment, a flame retarder, a neutralizing agent and an anti-foaming agent in addition to the aforementioned ingredients.

Thus, the processability and the formability of the electrically conductive rubber composition are improved when the ingredients are blended and kneaded for preparation of the electrically conductive rubber composition and when the electrically conductive rubber composition is formed into the roller body. Further, the roller body produced by forming the rubber composition and then crosslinking the base polymer is improved in mechanical strength, durability and the like, or improved in rubber characteristic properties (i.e., flexibility and resistance to permanent compressive deformation with a reduced compression set).

The inventive electrically conductive roller is advantageously used as the charging roller for electrically charging the photo receptor in contact with the surface of the photoreceptor in the electrophotographic image forming apparatus as described above.

According to the present invention, the electrically conductive roller can be provided, which has a stable roller resistance with little batch-to-batch variation in roller resistance and substantially without influence of the environmental conditions and the like, and is unlikely to contaminate the photoreceptor.

### BRIEF DESCRIPTION OF THE DRAWINGS

FIG. 1 is a perspective view showing an electrically conductive roller according to one embodiment of the present invention.

FIG. 2 is a diagram for explaining how to measure the roller resistance of the electrically conductive roller.

### EMBODIMENTS OF THE INVENTION

The present invention provides an electrically conductive roller which includes a roller body having a surface layer at least including an outer peripheral surface thereof and made of a crosslinking product of an electrically conductive rubber composition, and an oxide film formed in the outer peripheral surface by irradiation with ultraviolet radiation, the electrically conductive rubber composition comprising:

(1) a base polymer which is a mixture containing an epichlorohydrin rubber E and a diene rubber N in a mass ratio E/N of 50/50 to 80/20;
(2) a crosslinking component for crosslinking the base polymer; and
(3) a potassium salt of an anion having a fluoro group and a sulfonyl group in its molecule.

### <<Electrically Conductive Rubber Composition>>

### <Base Polymer>

The mass ratio E/N between the epichlorohydrin rubber E and the diene rubber N serving as the base polymer (1) is limited within the range of E/N=50/50 to 80/20 for the following reason:

The diene rubber N is a material for forming an oxide film functioning as a protective film in the outer peripheral surface of the roller body through oxidation by the irradiation with the ultraviolet radiation as described above. If the proportion of the diene rubber N is less than the aforementioned range, it is impossible to satisfactorily form the oxide film.

Therefore, when the resulting electrically conductive roller is incorporated, for example, as the charging roller in an image forming apparatus and brought into direct contact with a photoreceptor, a component of the electrically conductive rubber composition bloomed or bled onto the outer peripheral surface from the roller body cannot be effectively prevented from contaminating the photoreceptor and influencing an image to be formed.

Further, the outer peripheral surface of the roller body is changed by repeated image formation, so that additives contained in a toner are liable to adhere to the outer peripheral surface. This makes it impossible to effectively prevent the additives from influencing the image to be formed.

On the other hand, if the proportion of the epichlorohydrin rubber E is less than the aforementioned range, the epichlorohydrin rubber E cannot effectively impart the roller body with proper electrical conductivity, failing to control the roller resistance of the electrically conductive roller within the range suitable for the charging roller. Further, when the resulting electrically conductive roller is incorporated as the charging roller in the image forming apparatus and the image formation is repeated, the roller resistance is liable to further increase to cause an imaging failure in the formed image.

In contrast, where the mass ratio E/N between the epichlorohydrin rubber E and the diene rubber N serving as the base polymer falls within the aforementioned range, an oxide film sufficiently functioning as the protective film can be formed in the outer peripheral surface of the roller body. In addition, the roller resistance of the electrically conductive roller can be maintained within a range suitable for the image formation for a longer period of time from the initial stage.

### (Epichlorohydrin Rubber E)

Any of various polymers containing epichlorohydrin as a recurring unit and having an ion conductivity is usable as the epichlorohydrin rubber E.

Examples of the epichlorohydrin rubber E include epichlorohydrin homopolymers, epichlorohydrin-ethylene oxide bipolymers, epichlorohydrin-propylene oxide bipolymers, epichlorohydrin-allyl glycidyl ether bipolymers, epichlorohydrin-ethylene oxide-allyl glycidyl ether terpolymers, epichlorohydrin-propylene oxide-allyl glycidyl ether terpolymers and epichlorohydrin-ethylene oxide-propylene oxide-allyl glycidyl ether quaterpolymers, which may be used either alone or in combination.

Particularly, the ethylene oxide-containing copolymers are preferred as the epichlorohydrin rubber E, and such an ethylene oxide-containing copolymer preferably has an ethylene oxide content of 30 to 95 mol %, more preferably 55 to 95 mol %, particularly preferably 60 to 80 mol %.

Ethylene oxide functions to reduce the electrical resistance. If the ethylene oxide content is less than the aforementioned range, an electrical resistance reducing effect is reduced. On the other hand, if the ethylene oxide content is greater than the aforementioned range, ethylene oxide is more liable to be crystallized, whereby the segment motion of molecular chains is hindered to increase the electrical resistance. Further, there are possibilities that the roller body has a higher hardness after the crosslinking, and the electrically conductive rubber composition has a higher viscosity when being heat-melted before the crosslinking.

Particularly, the epichlorohydrin-ethylene oxide bipolymers (ECO) are preferred as the epichlorohydrin rubber E.

The ECO preferably has an ethylene oxide content of 30 to 80 mol %, particularly preferably 50 to 80 mol %, and preferably has an epichlorohydrin content of 20 to 70 mol %, particularly preferably 20 to 50 mol %.

The epichlorohydrin-ethylene oxide-allyl glycidyl ether terpolymers (GECO) are also usable as the epichlorohydrin rubber E.

The GECO preferably has an ethylene oxide content of 30 to 95 mol %, particularly preferably 60 to 80 mol %, and preferably has an epichlorohydrin content of 4.5 to 65 mol %, particularly preferably 15 to 40 mol %. Further, the GECO preferably has an allyl glycidyl ether content of 0.5 to 10 mol %, particularly preferably 2 to 6 mol %.

Examples of the GECO include copolymers of the three comonomers described above in a narrow sense, as well as known modification products obtained by modifying the ECO with allyl glycidyl ether. In the present invention, any of these copolymers are usable.

### (Diene Rubber N)

Examples of the diene rubber N include natural rubbers (NR), isoprene rubbers (IR), butadiene rubbers (BR), styrene-butadiene rubbers (SBR), chloroprene rubbers (CR) and acrylonitrile-butadiene rubbers (NBR), which may be used either alone or in combination. Particularly, the NBR is preferably used either alone or in combination with the CR. The CR and the NBR are particularly preferably used in combination.

The CR contains a great amount of chlorine atoms in its molecule and, therefore, has a function as the diene rubber N as well as a function of improving the charging characteristics of the inventive electrically conductive roller when the electrically conductive roller is used as the charging roller.

The NBR has a particularly excellent function as the diene rubber N, i.e., a particularly excellent function of forming an excellent oxide film as the protective film in the outer peripheral surface of the roller body through the oxidation by the irradiation with the ultraviolet radiation.

The CR and the NBR are polar rubbers and, therefore, have a function of finely controlling the roller resistance of the electrically conductive roller.

The CR is generally synthesized by emulsion polymerization of chloroprene, and may be classified in a sulfur modification type or a non-sulfur-modification type depending on the type of a molecular weight adjusting agent to be used for the emulsion polymerization.

The sulfur modification type CR is prepared by plasticizing a copolymer of chloroprene and sulfur (molecular weight adjusting agent) with thiuram disulfide or the like to adjust the viscosity of the copolymer to a predetermined viscosity level.

The non-sulfur-modification type CR may be classified, for example, in a mercaptan modification type, a xanthogen modification type or the like.

The mercaptan modification type CR is synthesized in substantially the same manner as the sulfur modification type CR, except that an alkyl mercaptan such as n-dodecyl mercaptan, tert-dodecyl mercaptan or octyl mercaptan, for example, is used as the molecular weight adjusting agent.

The xanthogen modification type CR is synthesized in substantially the same manner as the sulfur modification type CR, except that an alkylxanthogen compound, for example, is used as the molecular weight adjusting agent.

Further, the CR may be classified in a lower crystallization speed type, an intermediate crystallization speed type or a higher crystallization speed type depending on the crystallization speed.

In the present invention, any of the aforementioned types of CRs may be used. Particularly, a CR of the non-sulfur-modification type and the lower crystallization speed type is preferred.

Further, a copolymer of chloroprene and other comonomer may be used as the CR. Examples of the other comonomer include 2,3-dichloro-1,3-butadiene, 1-chloro-1,3-butadiene, styrene, acrylonitrile, methacrylonitrile, isoprene, butadiene, acrylic acid, acrylates, methacrylic acid and methacrylates, which may be used either alone or in combination.

Any of lower-acrylonitrile-content NBRs having an acrylonitrile content of not greater than 24%, an intermediate-acrylonitrile-content NBRs having an acrylonitrile content of 25 to 30%, intermediate- and higher-acrylonitrile-content NBRs having an acrylonitrile content of 31 to 35%, higher-acrylonitrile-content NBRs having an acrylonitrile content of 36 to 42%, and very-high-acrylonitrile-content NBRs having an acrylonitrile content of not lower than 43% may be used as the NBR.

Where the CR and the NBR are used in combination for the diene rubber N, the mass ratio CR/NBR between the CR and the NBR is preferably CR/NBR=15/85 to 35/65 in order to permit the CR and the NBR to properly perform their functions.

### <Potassium Salt>

Examples of the anion having the fluoro group and the sulfonyl group in its molecule for forming the potassium salt (3) together with the potassium cation include fluoroalkyl sulfonate ions, a bis(fluorosulfonyl)imide ion, bis(fluoroalkylsulfonyl)imide ions and tris(fluoroalkylsulfonyl)methide ions, which may be used either alone or in combination.

Examples of the fluoroalkyl sulfonate ions include CF₃SO₃⁻ and C₄F₉SO₃⁻, which may be used either alone or in combination.

The bis(fluorosulfonyl)imide ion is (FO₂S)₂N⁻.

Examples of the bis(fluoroalkylsulfonyl)imide ions include (CF₃SO₂)₂N⁻, (C₂F₅SO₂)₂N⁻, (C₄F₉SO₂)₂N⁻, (C₄F₉SO₂) (CF₃SO₂)N⁻ (FSO₂C₆F₄) (CF₃SO₂)N⁻, (C₈F₁₇SO₂) (CF₃SO₂)N⁻, (CF₃CH₂OSO₂)₂N⁻, (CF₃CF₂CH₂OSO₂)₂N⁻, (HCF₂CF₂CH₂OSO₂)₂N⁻ and [(CF₃)₂CHOSO₂]₂N⁻, which may be used either alone or in combination.

Examples of the tris(fluoroalkylsulfonyl)methide ions include (CF₃SO₂)₃C⁻ and (CF₃CH₂OSO₂)₃C⁻, which may be used either alone or in combination.

Specific examples of the potassium salt include potassium bis(fluorosulfonyl)imide [(FO₂S)₂NK], potassium bis(trifluoromethanesulfonyl)imide [(CF₃SO₂)₂NK] and potassium bis(nonafluorobutanesulfonyl)imide [(C₄F₉SO₂)₂NK], which may be used either alone or in combination.

Among these potassium salts, potassium bis(fluorosulfonyl)imide is preferred, which includes an anion having a smaller molecular weight and can reduce the roller resistance of the electrically conductive roller by increasing the amount of the potassium ion even with the addition of the same amount of the potassium salt.

For improvement of the electrical conductivity of the electrically conductive roller, the proportion of the potassium salt is preferably greater than 1 part by mass and not greater than 5 parts by mass, particularly preferably not less than 2 parts by mass and not greater than 4 parts by mass, based on 100 parts by mass of the base polymer of the electrically conductive rubber composition.

### <Crosslinking Component>

A thiourea crosslinking agent and an accelerating agent for crosslinking the epichlorohydrin rubber E, and at least one crosslinking agent selected from the group consisting of sulfur and a sulfur-containing crosslinking agent and a sulfur-containing accelerating agent for crosslinking the diene rubber N are preferably used in combination as the crosslinking component.

### (Thiourea Crosslinking Agent and Accelerating Agent)

Any of various thiourea crosslinking agents each having a thiourea group in a molecule thereof and capable of crosslinking the epichlorohydrin rubber E is usable as the thiourea crosslinking agent.

Examples of the thiourea crosslinking agent include tetramethylthiourea, trimethylthiourea, ethylene thiourea, and thioureas represented by (CₙH₂ₙ₊₁NH)₂C═S (wherein n is an integer of 1 to 10), which may be used either alone or in combination. Particularly, ethylene thiourea is preferred.

In order to properly crosslink the epichlorohydrin rubber E and to impart the roller body with advantageous rubber characteristic properties, i.e., to ensure that the roller body has proper flexibility and is substantially free from the permanent compressive deformation with a reduced compression set, it is preferred that the proportion of the thiourea crosslinking agent to be blended is not less than 0.3 parts by mass and not greater than 1 part by mass based on 100 parts by mass of the base polymer.

Examples of the accelerating agent include guanidine accelerating agents such as 1,3-diphenylguanidine (D), 1,3-di-o-tolylguanidine (DT) and 1-o-tolylbiguanide (BG), which may be used either alone or in combination.

The proportion of the accelerating agent is preferably not less than 0.3 parts by mass and not greater than 1 part by mass based on 100 parts by mass of the base polymer to sufficiently provide the effect of accelerating the crosslinking of the epichlorohydrin rubber E.

### (Sulfur, Sulfur-Containing Crosslinking Agent and Sulfur-Containing Accelerating Agent)

At least one selected from the group consisting of sulfur and a sulfur-containing crosslinking agent is used as the crosslinking agent for the diene rubber N.

Any of various organic compounds each containing sulfur in a molecule thereof and capable of crosslinking the diene rubber N is usable as the sulfur-containing crosslinking agent. An example of the sulfur-containing crosslinking agent is 4,4′-dithiodimorpholine (R).

Particularly, sulfur is preferred as the crosslinking agent.

In order to properly crosslink the diene rubber N and to impart the roller body with advantageous rubber characteristic properties, i.e., to ensure that the roller body has proper flexibility and is substantially free from the permanent compressive deformation with a reduced compression set, it is preferred that the proportion of sulfur to be blended is not less than 1 part by mass and not greater than 2 parts by mass based on 100 parts by mass of the base polymer.

Where the sulfur-containing crosslinking agent is used as the crosslinking agent, the proportion of the sulfur-containing crosslinking agent is preferably adjusted so that the proportion of sulfur contained in the molecule of the sulfur-containing crosslinking agent is within the aforementioned range based on 100 parts by mass of the base polymer.

Examples of the sulfur-containing accelerating agent include a thiazole accelerating agent, a thiuram accelerating agent, a sulfenamide accelerating agent and a dithiocarbamate accelerating agent, which may be used either alone or in combination. Among these sulfur-containing accelerating agents, the thiazole accelerating agent and the thiuram accelerating agent are preferably used in combination.

Examples of the thiazole accelerating agent include 2-mercaptobenzothiazole (M), di-2-benzothiazolyl disulfide (DM), a zinc salt of 2-mercaptobenzothiazole (MZ), a cyclohexylamine salt of 2-mercaptobenzothiazole (HM,M60-OT), 2-(N,N-diethylthiocarbamoylthio)benzothiazole (64) and 2-(4′-morpholinodithio)benzothiazole (DS, MDB), which may be used either alone or in combination. Particularly, di-2-benzothiazolyl disulfide (DM) is preferred.

Examples of the thiuram accelerating agent include tetramethylthiuram monosulfide (TS), tetramethylthiuram disulfide (TT, TMT), tetraethylthiuram disulfide (TET), tetrabutylthiuram disulfide (TBT), tetrakis(2-ethylhexyl)thiuram disulfide (TOT-N) and dipentamethylenethiuram tetrasulfide (TRA), which may be used either alone or in combination. Particularly, tetramethylthiuram monosulfide (TS) is preferred.

Where two types of sulfur-containing accelerating agents are used in combination, the proportion of the thiazole accelerating agent to be blended is preferably not less than 1 part by mass and not greater than 2 parts by mass based on 100 parts by mass of the base polymer in order to sufficiently provide the effect of accelerating the crosslinking of the diene rubber N. Similarly, the proportion of the thiuram accelerating agent to be blended is preferably not less than 0.3 parts by mass and not greater than 0.9 parts by mass based on 100 parts by mass of the base polymer.

### <Other Ingredients>

The electrically conductive rubber composition containing the aforementioned ingredients may further contain at least one additive selected from the group consisting of a crosslinking assisting agent, an acid accepting agent, a processing aid, a filler, an anti-aging agent, an antioxidant, an anti-scorching agent, a UV absorbing agent, a lubricant, a pigment, a flame retarder, a neutralizing agent and an anti-foaming agent.

Thus, the processability and the formability of the electrically conductive rubber composition are improved when the ingredients described above are blended and kneaded for preparation of the electrically conductive rubber composition and when the electrically conductive rubber composition is formed into the roller body. Further, the roller body produced by forming the rubber composition and then crosslinking the base polymer is improved in mechanical strength, durability and the like, or improved in rubber characteristic properties (i.e., flexibility and resistance to permanent compressive deformation with a reduced compression set).

Examples of the crosslinking assisting agent include metal oxides such as zinc oxide, and fatty acids such as stearic acid, oleic acid and cotton seed fatty acids, which may be used either alone or in combination.

The proportion of the crosslinking assisting agent to be blended is preferably not less than 3 parts by mass and not greater than 7 parts by mass based on 100 parts by mass of the base polymer.

In the presence of the acid accepting agent, chlorine-containing gases generated from the epichlorohydrin rubber E during the crosslinking of the electrically conductive rubber composition are prevented from remaining in the roller body, and from contaminating the photoreceptor drum. Hydrotalcites are preferred as the acid accepting agent because of their excellent dispersibility in the rubber.

The proportion of the acid accepting agent to be blended is preferably not less than 1 part by mass and not greater than 5 parts by mass based on 100 parts by mass of the base polymer.

Examples of the processing aid include an oil and a plasticizer.

Examples of the filler include zinc oxide, silica, carbon black, clay, talc, calcium carbonate, magnesium carbonate, aluminum hydroxide and alumina. Insulative or electrically less conductive carbon black is preferred as the carbon black, because it prevents variations in electrical resistance within the roller body.

Examples of the anti-scorching agent include N-cyclohexylthiophthalimide, phthalic anhydride, N-nitrosodiphenylamine and 2,4-diphenyl-4-methyl-1-pentene.

Conventionally known compounds may be additionally used.

The electrically conductive rubber composition can be prepared in a conventional manner. First, the epichlorohydrin rubber E and the diene rubber N are blended in a predetermined ratio, and simply kneaded. Then, additives other than the crosslinking component are added to the resulting mixture, which is in turn kneaded. Finally, the crosslinking component is added to the resulting mixture, which is in turn kneaded. Thus, the electrically conductive rubber composition is prepared.

A kneader, a Banbury mixer, an extruder or the like, for example, is usable for the kneading.

### <<Electrically Conductive Roller>>

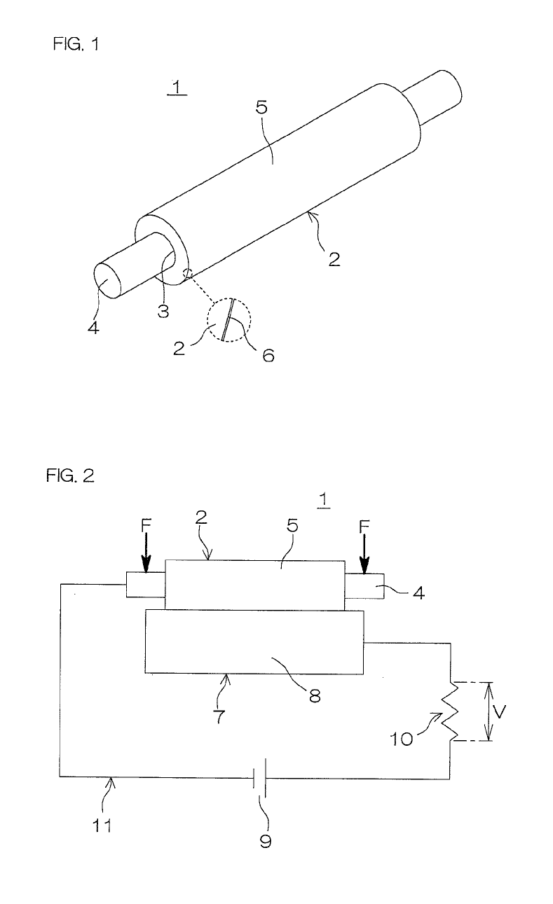

FIG. 1 is a perspective view of an electrically conductive roller according to one embodiment of the present invention.

Referring to FIG. 1, the electrically conductive roller 1 according to this embodiment includes a cylindrical roller body 2 formed from the aforementioned electrically conductive rubber composition, and a shaft 4 inserted through a center hole 3 of the roller body 2. The roller body 2 includes an oxide film 6 formed in an outer peripheral surface 5 thereof by irradiation with ultraviolet radiation.

The shaft 4 is a unitary member formed of a metal such as aluminum, an aluminum alloy or a stainless steel. The roller body 2 and the shaft 4 are electrically connected to each other and mechanically fixed to each other for unitary rotation, for example, by an electrically conductive adhesive or the like.

The inventive electrically conductive roller is incorporated in an electrophotographic image forming apparatus such as a laser printer to be advantageously used as a charging roller for uniformly electrically charging a surface of a photoreceptor. Thus, the image forming apparatus can have a higher printing speed as compared with the conventional image forming apparatus.

Where the electrically conductive roller is used as the charging roller, the roller body 2 preferably has a thickness of not less than 0.5 mm and not greater than 15 mm, more preferably not less than 1 mm and not greater than 10 mm, particularly preferably not less than 3 mm and not greater than 7 mm, in order to provide a proper nip thickness while achieving the size reduction and the weight reduction of the charging roller.

The roller body 2 is produced in a conventional manner with the use of the electrically conductive rubber composition containing the aforementioned ingredients. More specifically, the electrically conductive rubber composition is heat-melted while being kneaded by means of an extruder. In this state, the electrically conductive rubber composition is extruded into an elongated cylindrical shape through a die configured as corresponding to the cross sectional shape (i.e., the annular shape) of the roller body 2, and then cooled to be solidified. Thereafter, a temporary crosslinking shaft is inserted into a hole 3 of the resulting product, which is heated in a vulcanization can for crosslinking.

Then, the temporary shaft is removed from the resulting product, which is in turn attached to a shaft 4 having an outer peripheral surface to which an electrically conductive adhesive is applied. Where the adhesive is a thermosetting adhesive, the thermosetting adhesive is heated to be cured. Thus, the roller body 2 and the shaft 4 are electrically connected to each other and mechanically fixed to each other.

As required, an outer peripheral surface 5 of the roller body 2 is polished to a predetermined surface roughness, and then irradiated with ultraviolet radiation, whereby the diene rubber in the crosslinking product of the electrically conductive rubber composition in the outer peripheral surface 5 is oxidized. Thus, an oxide film 6 is formed as covering the outer peripheral surface 5. In this manner, the electrically conductive roller 1 shown in FIG. 1 is produced.

Since the oxide film 6 is formed by oxidizing the outer peripheral surface 5 of the roller body 2 made of the crosslinking product of the electrically conductive rubber composition containing the aforementioned ingredients, the oxide film 6 has excellent protective film properties such that the component of the electrically conductive rubber composition bloomed or bled onto the outer peripheral surface 5 is prevented from contaminating the photoreceptor and additives such as silica added to the toner are prevented from being accumulated on the outer peripheral surface 5 of the roller body 2 and influencing an image to be formed.

A contamination resistance test is performed, in which the roller body 2 is allowed to stand still at a temperature of 50° C. at a relative humidity of 90% for 30 days with the outer peripheral surface 5 thereof kept in contact with the surface of the photoreceptor for subsequently checking if an image formed by using the photoreceptor is influenced. At this time, it is possible to prevent the influence on the formed image.

The roller body 2 may have a double layer structure including an outer layer adjacent to the outer peripheral surface 5 and an inner layer adjacent to the shaft 4. In this case, at least the outer layer is formed from the electrically conductive rubber composition.

The inventive electrically conductive roller 1 has a roller resistance of less than 10⁵Ω as measured in an ordinary temperature/ordinary humidity environment at a temperature of 23° C. at a relative humidity of 55% while applying a voltage of 500 V. Thus, an image forming apparatus having a higher printing speed than conventional image forming apparatuses can be provided, for example, by employing the electrically conductive roller 1 as the charging roller.

It is noted that the roller resistance of the electrically conductive roller 1 is a roller resistance measured with the oxide film 6 formed in the outer peripheral surface 5.

### <<Method of Measuring Roller Resistance>>

FIG. 2 is a diagram for explaining how to measure the roller resistance of the electrically conductive roller 1.

Referring to FIGS. 1 and 2, the roller resistance is expressed by a value determined by the following measurement method in the present invention.

An aluminum drum 7 rotatable at a constant rotation speed is prepared, and the outer peripheral surface 5 (formed with the oxide film 6) of the roller body 2 of the electrically conductive roller 1 to be subjected to the measurement of the roller resistance is brought into abutment against an outer peripheral surface 8 of the aluminum drum 7 from above.

A DC power source 9 and a resistor 10 are connected in series between the shaft 4 of the electrically conductive roller 1 and the aluminum drum 7 to provide a measurement circuit 11. The DC power source 9 is connected to the shaft 4 at its negative terminal, and connected to the resistor 10 at its positive terminal. The resistor 10 has a resistance r of 100 Ω.

Subsequently, a load F of 450 g is applied to each of opposite end portions of the shaft 4 to bring the roller body 2 into press contact with the aluminum drum 7 and, in this state, a detection voltage V applied to the resistor 10 is measured by applying an application voltage E of DC 200 V from the DC power source 9 between the shaft 4 and the aluminum drum 7 while rotating the aluminum drum 7 (at a rotation speed of 40 rpm).

The roller resistance R of the electrically conductive roller 1 is basically determined from the following expression (1′) based on the detection voltage V and the application voltage E (=200 V):

R=r×E/(V−r) (1′)

However, the term −r in the denominator of the expression (1′) is negligible, so that the roller resistance of the electrically conductive roller 1 is expressed by a value determined from the following expression (1) in the present invention:

R=r×E/V (1)

A temperature of 23° C. and a relative humidity of 55% are employed as conditions for the measurement as described above.

The hardness and the compression set of the roller body 2 can be controlled according to the use purpose of the electrically conductive roller 1. The control of the hardness, the compression set, the roller resistance and the like can be achieved, for example, by controlling the mass ratio E/N between the epichlorohydrin rubber E and the diene rubber N within the aforementioned range, and controlling the types and the amounts of the thiourea crosslinking component and the sulfur vulcanization component for the crosslinking component.

The inventive electrically conductive roller can be used as the charging roller as well as a developing roller, a transfer roller, a cleaning roller and the like in an electrophotographic image forming apparatus such as a laser printer, an electrostatic copying machine, a plain paper facsimile machines or a printer-copier-facsimile multifunction machine.

### EXAMPLES

Electrically conductive rollers of Examples and Comparative Examples were prepared and tested at a temperature of 23° C. at a relative humidity of 55%, unless otherwise specified.

### Example 1

A base polymer was prepared by blending 60 parts by mass of ECO (EPICHLOMER (registered trade name) D available from Daiso Co., Ltd. and having an ethylene oxide content of 61 mol %) as the epichlorohydrin rubber E, and 10 parts by mass of CR(SHOPRENE (registered trade name) WRT available from Showa Denko K.K.) and 30 parts by mass of NBR (JSR N250 SL (lower-acrylonitrile-content NBR having an acrylonitrile content of 20%) available from JSR Co., Ltd) as the diene rubber N. While the base polymer was kneaded by means of a 9L kneader, 2.5 parts by mass of potassium bis(trifluoromethanesulfonyl)imide ((CF₃SO₂)₂NK EF-N112, K-TFSI available from Mitsubishi Materials Electronic Chemicals Co., Ltd.) as the potassium salt and ingredients shown below in Table 1 were added to and kneaded with the base polymer. Thus, an electrically conductive rubber composition was prepared.

The mass ratio E/N between the epichlorohydrin rubber E and the diene rubber N was E/N=60/40.

TABLE 1

| Ingredients | Parts by mass |
|---|---|
| Thiourea crosslinking agent | 0.6 |
| Accelerating agent DT | 0.54 |
| Sulfur powder | 1.5 |
| Accelerating agent DM | 1.5 |
| Accelerating agent TS | 0.5 |
| Zinc oxide Type-2 | 5 |
| Acid accepting agent | 5 |

The ingredients shown in Table 1 will be detailed below:

Thiourea crosslinking agent: ethylene thiourea (ACCEL (registered trade name) 22-S available from Kawaguchi Chemical Industry Co., Ltd.)
Accelerating agent DT: 1,3-di-o-tolylguanidine (guanidine accelerating agent NOCCELER (registered trade name) DT available from Ouchi Shinko Chemical Industrial Co., Ltd.)
Sulfur powder: vulcanizing agent (available from Tsurumi Chemical Industry Co., Ltd.)
Accelerating agent DM: di-2-benzothiazolyl disulfide (thiazole accelerating agent NOCCELER DM available from Ouchi Shinko Chemical Industrial Co., Ltd.)
Accelerating agent TS: tetramethylthiuram monosulfide (thiuram accelerating agent NOCCELER TS available from Ouchi Shinko Chemical Industrial Co., Ltd.)
Zinc oxide Type-2: crosslinking assisting agent (available from Mitsui Mining & Smelting Co., Ltd.)
Acid accepting agent: hydrotalcites (DHT-4A (registered trade name) 2 available from Kyowa Chemical Industry Co., Ltd.)

The amounts (parts by mass) of the ingredients shown in Table 1 are based on 100 parts by mass of the base polymer.

The electrically conductive rubber composition was fed into a φ60 extruder and then extruded into a hollow cylindrical shape having an outer diameter of 13.0 mm and an inner diameter of 5.5 mm. Then, the resulting cylindrical body was fitted around a temporary crosslinking shaft having an outer diameter of 3 mm, and crosslinked at 160° C. for 30 minutes in a vulcanization can.

Subsequently, the resulting cylindrical body was removed from the temporary crosslinking shaft, then fitted around a shaft having an outer diameter of 6 mm and an outer peripheral surface to which an electrically conductive thermosetting adhesive agent (polyamide adhesive) was applied, and heated to 150° C. for 60 minutes in an oven. Thus, the cylindrical body was bonded to the shaft. Thereafter, opposite end portions of the cylindrical body were trimmed. Subsequently, the outer peripheral surface of the cylindrical body was ground to an outer diameter of 12.0 mm by means of a wide polisher.

After the grinding, the outer peripheral surface of the resulting roller body was cleaned with an alcohol pad. Then, the roller body was set in a UV treatment apparatus with its outer peripheral surface spaced 50 mm from a UV light source. Then, the roller body was irradiated with ultraviolet radiation for 15 minutes, while being rotated at 30 rpm. Thus, an oxide film was formed in the outer peripheral surface. In this manner, an electrically conductive roller was produced.

### Example 2

An electrically conductive rubber composition was prepared in substantially the same manner as in Example 1, except that 2.5 parts by mass of potassium bis(fluorosulfonyl)imide ((FO₂S)₂NK) K-FSI available from Mitsubishi Materials Electronic Chemicals Co., Ltd.) was blended as the potassium salt. Then, an electrically conductive roller was produced by using the electrically conductive rubber composition thus prepared. The mass ratio E/N between the epichlorohydrin rubber E and the diene rubber N was E/N=60/40.

### Examples 3 and 4

Electrically conductive rubber compositions were prepared in substantially the same manners as in Examples 1 and 2, except that the CR was not blended as the diene rubber N of the base polymer and the proportion of the NBR was 40 parts by mass. Then, electrically conductive rollers were produced by using the electrically conductive rubber compositions thus prepared. The mass ratio E/N between the epichlorohydrin rubber E and the diene rubber N was E/N=60/40.

### Comparative Example 1

An electrically conductive rubber composition was prepared in substantially the same manner as in Example 1, except that 2.5 parts by mass of lithium bis(trifluoromethanesulfonyl)imide ((CF₃SO₂)₂NLi Li-TFSI available from Morita Chemical Industries Co., Ltd.) was blended as a lithium salt instead of the potassium salt. Then, an electrically conductive roller was produced by using the electrically conductive rubber composition thus prepared. The mass ratio E/N between the epichlorohydrin rubber E and the diene rubber N was E/N=60/40.

### Comparative Example 2

An electrically conductive rubber composition was prepared in substantially the same manner as in Example 1, except that 2.5 parts by mass of lithium bis(nonafluorobutanesulfonyl)imide ((C₄F₉SO₂)₂NLi EF-N445, Li-NFSI available from Mitsubishi Materials Electronic Chemicals Co., Ltd.) was blended as a lithium salt instead of the potassium salt. Then, an electrically conductive roller was prepared by using the electrically conductive rubber composition thus prepared. The mass ratio E/N between the epichlorohydrin rubber E and the diene rubber N was E/N=60/40.

### <Measurement of Roller Resistance>

The roller resistance of each of the electrically conductive rollers produced in Examples and Comparative Examples was measured in an ordinary temperature/ordinary humidity environment at a temperature of 23° C. at a relative humidity of 55% by the measurement method described above.

An electrically conductive roller having a roller resistance of not greater than 10^{5.5}Ω was rated as acceptable, and an electrically conductive roller having a roller resistance of greater than 10^{5.5}Ω was rated as unacceptable. In Tables 2 to 4, the roller resistances are expressed in log R.

### <Batch-to-Batch Variations in Roller Resistance>

The electrically conductive rubber compositions of Examples and Comparative Examples were each prepared in five batches, and electrically conductive rollers were produced by using electrically conductive rubber compositions prepared in the respective batches. Then, the roller resistance of each of the electrically conductive rollers thus produced was measured. A difference between the maximum value and the minimum value of the roller resistance was determined.

An electrically conductive roller having a difference of not greater than 0.4 as expressed in log R was rated as acceptable, and an electrically conductive roller having a difference of greater than 0.4 as expressed in log R was rated as unacceptable.

### <Feasibility Test>

A laser printer toner cartridge (IMAGE DRUM ID-C4DC (cyan) available from Oki Data Corporation) including a photoreceptor drum and a charging roller constantly kept in contact with a surface of the photoreceptor drum was prepared. The electrically conductive rollers produced in Examples and Comparative Examples were each incorporated instead of the charging roller in the toner cartridge.

Immediately after the resulting toner cartridge was incorporated in a color laser printer (C5900dn available from Oki Data Corporation), a halftone image and a solid image were printed by means of the color laser printer in an ordinary temperature/ordinary humidity environment at a temperature of 23° C. at a relative humidity of 55%. These images were evaluated as initial images.

After a printing test was performed at a rate of 2000 sheets/day for 7 days in the ordinary temperature/ordinary humidity environment, a halftone image and a solid image were printed. These images were evaluated as post-test images.

The images were visually checked. An image suffering from a certain abnormality was rated as unacceptable (x), and an image free from the abnormality was rated as acceptable (∘).

Further, the toner cartridges were each allowed to stand still in a higher temperature/higher humidity environment at a temperature of 50° C. at a relative humidity of 90% for 30 days, and then incorporated in the color laser printer. Then, a halftone image and a solid image were printed.

An electrically conductive roller which caused an imaging failure (streaking) along a portion of the photoreceptor drum kept in contact with the electrically conductive roller during the stand-still period due to contamination of the photoreceptor drum (contamination with a component of the electrically conductive rubber composition bloomed or bled onto the outer peripheral surface of the electrically conductive roller) and, even after sequential formation of 20 or more images, still caused the imaging failure was rated as unacceptable (x). An electrically conductive roller which caused an imaging failure in initial several images (due to contamination with absorbed moisture) but, thereafter, did not cause the imaging failure was rated as acceptable (Δ), and an electrically conductive roller which did not cause an imaging failure even in the first image was rated as excellent (∘).

The results are shown in Table 2.

TABLE 2

| Example | Example | Example | Example | Comparative | Comparative |
|---|---|---|---|---|---|
| 1 | 2 | 3 | 4 | Example 1 | Example 2 |

Parts by mass

| | | | | | | |
|---|---|---|---|---|---|---|
| Base polymer | | | | | | |
| ECO (E) | 60 | 60 | 60 | 60 | 60 | 60 |
| CR (N) | 10 | 10 | — | — | 10 | 10 |
| NBR (N) | 30 | 30 | 40 | 40 | 30 | 30 |
| E/N | 60/40 | 60/40 | 60/40 | 60/40 | 60/40 | 60/40 |
| Potassium salt | | | | | | |
| K-TFSI | 2.5 | — | 2.5 | — | — | — |
| K-FSI | — | 2.5 | — | 2.5 | — | — |
| Lithium salt | | | | | | |
| Li-TFSI | — | — | — | — | 2.5 | — |
| Li-NFSI | — | — | — | — | — | 2.5 |

Evaluation

| | | | | | | |
|---|---|---|---|---|---|---|
| Roller resistance (log R) | 5.0 | 4.8 | 5.1 | 4.9 | 4.9 | 5.2 |
| Difference in roller resistance (log R) | 0.3 | 0.3 | 0.3 | 0.3 | 0.6 | 0.6 |
| Feasibility test | | | | | | |
| Initial image | ∘ | ∘ | ∘ | ∘ | ∘ | ∘ |
| Post-test image | ∘ | ∘ | ∘ | ∘ | ∘ | ∘ |
| Contamination of photoreceptor | ∘ | ∘ | ∘ | ∘ | Δ | Δ |

The results for Comparative Examples 1 and 2 in Table 2 indicate that, where the lithium salts were used as the ionic electrically-conductive salt, there were greater batch-to-batch variations in roller resistance due to the hygroscopic and deliquescent properties of the lithium salt, and the photoreceptor was contaminated with moisture absorbed by the electrically conductive roller in the higher temperature/higher humidity environment.

In contrast, the results for Examples 1 to 4 indicate that, where the potassium salts were used instead of the lithium salts, there were smaller batch-to-batch variations in roller resistance, and the photoreceptor was not contaminated, because the potassium salts were non-hygroscopic and non-deliquescent unlike the lithium salt. In comparison of Examples 1 to 4, electrically conductive rollers of Examples 2 and 4 which employed the potassium bis(fluorosulfonyl)imide having a smaller molecular weight each had a smaller roller resistance than the electrically conductive rollers of Examples 1 and 3 even with the addition of the same amount of the potassium salts.

### Example 5

An electrically conductive rubber composition was prepared in substantially the same manner as in Example 1, except that the ECO (epichlorohydrin rubber E), and the CR and the NBR (diene rubber N) were blended in proportions of 50 parts by mass, 10 parts by mass and 40 parts by mass, respectively, for the base polymer. Then, an electrically conductive roller was produced by using the electrically conductive rubber composition thus prepared. The mass ratio E/N between the epichlorohydrin rubber E and the diene rubber N was E/N=50/50.

### Example 6

An electrically conductive rubber composition was prepared in substantially the same manner as in Example 1, except that the ECO (epichlorohydrin rubber E), and the CR and the NBR (diene rubber N) were blended in proportions of 80 parts by mass, 5 parts by mass and 15 parts by mass, respectively, for the base polymer. Then, an electrically conductive roller was produced by using the electrically conductive rubber composition thus prepared. The mass ratio E/N between the epichlorohydrin rubber E and the diene rubber N was E/N=80/20.

### Comparative Example 3

An electrically conductive rubber composition was prepared in substantially the same manner as in Example 1, except that the ECO (epichlorohydrin rubber E), and the CR and the NBR (diene rubber N) were blended in proportions of 40 parts by mass, 10 parts by mass and 50 parts by mass, respectively, for the base polymer. Then, an electrically conductive roller was produced by using the electrically conductive rubber composition thus prepared. The mass ratio E/N between the epichlorohydrin rubber E and the diene rubber N was E/N=40/60.

### Comparative Example 4

An electrically conductive rubber composition was prepared in substantially the same manner as in Example 1, except that the ECO (epichlorohydrin rubber E), and the CR and the NBR (diene rubber N) were blended in proportions of 85 parts by mass, 5 parts by mass and 10 parts by mass, respectively, for the base polymer. Then, an electrically conductive roller was produced by using the electrically conductive rubber composition thus prepared. The mass ratio E/N between the epichlorohydrin rubber E and the diene rubber N was E/N=85/15.

The electrically conductive rollers of Examples 5 and 6 and Comparative Examples 3 and 4 were evaluated by performing the aforementioned tests. The results for Examples 5 and 6 and Comparative Examples 3 and 4 as well as for Example 1 are shown in Table 3.

TABLE 3

| Compar- | Exam- | Exam- | Exam- | Compar- |
|---|---|---|---|---|
| ative | ple | ple | ple | ative |
| Example 3 | 5 | 1 | 6 | Example 4 |

Parts by mass

| | | | | | |
|---|---|---|---|---|---|
| Base polymer | | | | | |
| ECO (E) | 40 | 50 | 60 | 80 | 85 |
| CR (N) | 10 | 10 | 10 | 5 | 5 |
| NBR (N) | 50 | 40 | 30 | 15 | 10 |
| E/N | 40/60 | 50/50 | 60/40 | 80/20 | 85/15 |
| Potassium salt | | | | | |
| K-TFSI | 2.5 | 2.5 | 2.5 | 2.5 | 2.5 |
| K-FSI | — | — | — | — | — |
| Lithium salt | | | | | |
| Li-TFSI | — | — | — | — | — |
| Li-NFSI | — | — | — | — | — |

Evaluation

| | | | | | |
|---|---|---|---|---|---|
| Roller resistance | 5.5 | 5.2 | 5.0 | 4.5 | 4.4 |
| (log R) | | | | | |
| Difference in | 0.6 | 0.4 | 0.3 | 0.3 | 0.3 |
| roller resistance | | | | | |
| (log R) | | | | | |
| Feasibility test | | | | | |
| Initial image | ∘ | ∘ | ∘ | ∘ | ∘ |
| Post-test image | x | ∘ | ∘ | ∘ | x |
| Contamination of | ∘ | ∘ | ∘ | ∘ | x |
| photoreceptor | | | | | |

The results for Comparative Example 3 in Table 3 indicate that, where the proportion of the epichlorohydrin rubber E was less than the mass ratio E/N between the epichlorohydrin rubber E and the diene rubber N of 50/50, it was impossible to control the roller resistance of the electrically conductive roller within the range suitable for the charging roller and, when the electrically conductive roller was incorporated as the charging roller in the image forming apparatus and the image formation was repeated, the roller resistance was further increased, thereby causing an imaging failure in the formed image.

The results for Comparative Example 4 indicate that, where the proportion of the diene rubber N was less than the mass ratio E/N of 80/20, it was impossible to form an oxide film sufficiently functioning as a protective film in the outer peripheral surface of the roller body and, when the electrically conductive roller was incorporated as the charging roller in the image forming apparatus to be brought into direct contact with the photoreceptor, the photoreceptor was contaminated with the component of the electrically conductive rubber composition bloomed or bled onto the outer peripheral surface from the roller body, thereby influencing the formed image.

Further, the outer peripheral surface of the roller body was changed by the repeated image formation, so that additives contained in the toner were liable to adhere to the outer peripheral surface to influence the formed image, resulting in an imaging failure in the formed image.

In contrast, the results for Examples 1, 5 and 6 indicate that, where the mass ratio E/N was within the range of 50/50 to 80/20, it was possible to form an oxide film sufficiently functioning as the protective film in the outer peripheral surface of the roller body and to maintain the roller resistance of the electrically conductive roller within the range suitable for the image formation for a longer period of time from the initial stage, thereby preventing the various imaging failures and the contamination of the photoreceptor.

### Examples 7 and 8 and Comparative Examples 5 and 6

Electrically conductive rubber compositions were prepared in substantially the same manners as in Examples 5 and 6 and Comparative Examples 3 and 4, except that 2.5 parts by mass of potassium bis(fluorosulfonyl)imide ((FO₂S)₂NK K-FSI available from Mitsubishi Materials Electronic Chemicals Co., Ltd.) was blended as the potassium salt. Then, electrically conductive rollers were prepared by using the respective electrically conductive rubber compositions thus prepared.

The electrically conductive rollers of Examples 7 and 8 and Comparative Examples 5 and 6 were evaluated by performing the aforementioned tests. The results for Examples 7 and 8 and Comparative Examples 5 and 6 as well as for Example 2 are shown in Table 4.

TABLE 4

| Compar- | Exam- | Exam- | Exam- | Compar- |
|---|---|---|---|---|
| ative | ple | ple | ple | ative |
| Example 5 | 7 | 2 | 8 | Example 6 |

Parts by mass

| | | | | | |
|---|---|---|---|---|---|
| Base polymer | | | | | |
| ECO (E) | 40 | 50 | 60 | 80 | 85 |
| CR (N) | 10 | 10 | 10 | 5 | 5 |
| NBR (N) | 50 | 40 | 30 | 15 | 10 |
| E/N | 40/60 | 50/50 | 60/40 | 80/20 | 85/15 |
| Potassium salt | | | | | |
| K-TFSI | — | — | — | — | — |
| K-FSI | 2.5 | 2.5 | 2.5 | 2.5 | 2.5 |
| Lithium salt | | | | | |
| Li-TFSI | — | — | — | — | — |
| Li-NFSI | — | — | — | — | — |

Evaluation

| | | | | | |
|---|---|---|---|---|---|
| Roller resistance | 5.8 | 5.3 | 4.8 | 4.6 | 4.6 |
| (log R) | | | | | |
| Difference in | 0.3 | 0.3 | 0.3 | 0.3 | 0.3 |
| roller resistance | | | | | |
| (log R) | | | | | |
| Feasibility test | | | | | |
| Initial image | ∘ | ∘ | ∘ | ∘ | ∘ |
| Post-test image | x | ∘ | ∘ | ∘ | x |
| Contamination of | ∘ | ∘ | ∘ | ∘ | x |
| photoreceptor | | | | | |

The results shown in Table 4 indicate that the system employing potassium bis(fluorosulfonyl)imide as the potassium salt provided the same effects as the system employing potassium bis(trifluoromethanesulfonyl)imide as the potassium salt shown in Table 3.

More specifically, the results for Comparative Example 5 shown in Table 4 indicate that, where the proportion of the epichlorohydrin rubber E was less than the mass ratio E/N between the epichlorohydrin rubber E and the diene rubber N of 50/50, it was impossible to control the roller resistance of the electrically conductive roller within the range suitable for the charging roller and, when the electrically conductive roller was incorporated as the charging roller in the image forming apparatus and the image formation was repeated, the roller resistance was further increased, thereby causing an imaging failure in the formed image.

The results for Comparative Example 6 indicate that, where the proportion of the diene rubber N was less than the mass ratio E/N of 80/20, it was impossible to form an oxide film sufficiently functioning as the protective film in the outer peripheral surface of the roller body and, when the electrically conductive roller is incorporated as the charging roller in the image forming apparatus to be brought into direct contact with the photoreceptor, the photoreceptor was contaminated with the component of the electrically conductive rubber composition bloomed or bled onto the outer peripheral surface from the roller body, thereby influencing the formed image.

Further, the outer peripheral surface of the roller body was changed by the repeated image formation, so that additives contained in the toner were liable to adhere to the outer peripheral surface to influence the formed image, resulting in an imaging failure in the formed image.

In contrast, the results for Examples 2, 7 and 8 indicate that, where the mass ratio E/N was within the range of 50/50 to 80/20, it was possible to form an oxide film sufficiently functioning as the protective film in the outer peripheral surface of the roller body and to maintain the roller resistance of the electrically conductive roller within the range suitable for the image formation for a longer period of time from the initial stage, thereby preventing the various imaging failures and the contamination of the photoreceptor.

This application corresponds to Japanese Patent Application No. 2012-103667 filed in the Japan Patent Office on Apr. 27, 2012, the disclosure of which is incorporated herein by reference in its entirety.

What is claimed is:

1. An electrically conductive roller comprising:
a roller body having a surface layer at least including an outer peripheral surface thereof and made of a crosslinking product of an electrically conductive rubber composition; and
an oxide film formed in the outer peripheral surface by irradiation with ultraviolet radiation;
the electrically conductive rubber composition comprising:
(1) a base polymer which is a mixture comprising an epichlorohydrin rubber E and a diene rubber N in a mass ratio E/N of 50/50 to 80/20;
(2) a crosslinking component for crosslinking the base polymer; and
(3) a potassium salt of an anion having a fluoro group and a sulfonyl group in its molecule.

2. The electrically conductive roller according to claim 1, wherein the salt (3) is potassium bis(fluorosulfonyl)imide.

3. The electrically conductive roller according to claim 2, wherein the crosslinking component (2) comprises a thiourea crosslinking agent and an accelerating agent for crosslinking the epichlorohydrin rubber, and at least one crosslinking agent selected from the group consisting of sulfur and a sulfur-containing crosslinking agent and a sulfur-containing accelerating agent for crosslinking the diene rubber.

4. The electrically conductive roller according to claim 3, wherein the electrically conductive rubber composition further comprises at least one additive selected from the group consisting of a crosslinking assisting agent, an acid accepting agent, a processing aid, a filler, an anti-aging agent, an antioxidant, an anti-scorching agent, a UV absorbing agent, a lubricant, a pigment, a flame retarder, a neutralizing agent and an anti-foaming agent.

5. The electrically conductive roller according to claim 1, wherein the crosslinking component (2) comprises a thiourea crosslinking agent and an accelerating agent for crosslinking the epichlorohydrin rubber, and at least one crosslinking agent selected from the group consisting of sulfur and a sulfur-containing crosslinking agent and a sulfur-containing accelerating agent for crosslinking the diene rubber.

6. The electrically conductive roller according to claim 1, wherein the electrically conductive rubber composition further comprises at least one additive selected from the group consisting of a crosslinking assisting agent, an acid accepting agent, a processing aid, a filler, an anti-aging agent, an antioxidant, an anti-scorching agent, a UV absorbing agent, a lubricant, a pigment, a flame retarder, a neutralizing agent and an anti-foaming agent.

7. The electrically conductive roller according to claim 1, which is used as a charging roller for electrically charging a photoreceptor in contact with a surface of the photoreceptor in an electrophotographic image forming apparatus.

8. The electrically conductive roller according to claim 4, which is used as a charging roller for electrically charging a photoreceptor in contact with a surface of the photoreceptor in an electrophotographic image forming apparatus.
